(19) United States
(12) Patent Application Publication
(10) Pub. No.: US 2010/0110219 A1
(43) Pub. Date: May 6, 2010

(54) ELECTRONIC CAMERA

(75) Inventors: Risa KAICHI, Moriguchi-shi (JP); Kazunori MIYATA, Shijonawate-Shi (JP)

Correspondence Address: NOVAK DRUCE + QUIGG LLP, 1300 EYE STREET NW, SUITE 1000 WEST TOWER, WASHINGTON, DC, 20005, US

(73) Assignee: SANYO ELECTRIC CO., LTD., Osaka (JP)

(21) Appl. No.: 12/610,121

(22) Filed: Oct. 30, 2009

(30) Foreign Application Priority Data
Oct. 31, 2008 (JP) 2008-280986

(51) Int. Cl. H04N 5/228

(52) U.S. Cl. 348/222.1; 348/E05.031

(57) ABSTRACT

An electronic camera includes an imager. The imager produces an image representing an object scene. An LED device is arranged on a front surface of a camera casing. A CPU searches a face image of a person from the image produced by the imager, and causes a light-emitting operation of the LED device to differ depending on a search result. The LED device is set to non-light emission when the number of detected face images is “0”, emits light in red when the number of detected face images is “1”, and emits light in green when the number of detected face images is equal to or more than “2”.

### CROSS REFERENCE OF RELATED APPLICATION

The disclosure of Japanese Patent Application No. 2008-280986, which was filed on Oct. 31, 2008, is incorporated herein by reference.

### BACKGROUND OF THE INVENTION

1. Field of the Invention

The present invention relates to an electronic camera. More particularly, the present invention relates to an electronic camera which detects a specific object image, such as a face image of a person, from an object scene image captured by an imaging device.

2. Description of the Related Art

According to one example of this type of camera, a through image based on an object scene image repeatedly captured by an imaging device is displayed on an LCD monitor, and in parallel therewith, a face image is searched from the object scene image of each frame. When the face image is discovered, a character representing a face frame structure is displayed on the LCD monitor in an OSD manner.

However, in the above-described camera, the character representing the face frame structure is displayed on the LCD monitor. Therefore, in a case that a manipulator is on an object scene side in order to photograph a user him/herself (so-called self shooting), it is not possible to confirm the character of the face frame structure, i.e., a detection state of the face image, and as a result, a manipulability is decreased.

### SUMMARY OF THE INVENTION

An electronic camera according to the present invention, comprises: an imager which produces an image representing an object scene; a searcher which searches a specific object image from the image produced by the imager; and a notifier which outputs notifications different depending on each search result of the searcher, toward the object scene.

Preferably, further comprised is an adjustor which adjusts an imaging parameter according to a parameter-adjusting manipulation, wherein the notifier executes a notifying process in association with an adjusting process of the adjustor.

Preferably, the notifier includes a determiner which determines the number of specific object images discovered by the searcher and a selector which selects a notifying manner corresponding to the number determined by the determiner.

More preferably, further comprised is a recorder which records the image produced by the imager in response to a recording manipulation, wherein the determiner repeatedly executes the determining process until the recording manipulation is performed.

More preferably, the imager repeatedly produces the image, and the electronic camera further comprises: a moving image outputter which outputs a moving image based on the image produced by the imager, toward a predetermined direction; and an information outputter which outputs information corresponding to the search result of the searcher, toward the predetermined direction.

Preferably, the specific object image is equivalent to a face image of a person.

According to the present invention, an imaging controlling program product executed by a processor of an electronic camera provided with an imager which produces an image representing an object scene comprises: a searching step of searching a specific object image from the image produced by the imager; and a notifying step of outputting notifications different depending on each search result in the searching step, toward the object scene.

According to the present invention, an imaging controlling method executed by an electronic camera provided with an imager which produces an image representing an object scene comprises: a searching step of searching a specific object image from the image produced by the imager; and a notifying step of outputting notifications different depending on each search result in the searching step, toward the object scene.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a configuration of one embodiment of the present invention;

FIG. 2 is an illustrative view showing one example of a state that an evaluation area is allocated to an imaging surface;

FIG. 3 is an illustrative view showing one portion of a face detecting operation;

FIG. 4 is an illustrative view showing one example of a dictionary referenced in the embodiment in FIG. 1;

FIG. 5 is an illustrative view showing one example of a plurality of face-detection frame structures used for a face recognizing process;

FIG. 6 is an illustrative view showing one example of a table referenced by the embodiment of FIG. 1;

FIG. 7(A) is an illustrative view showing one example of a state that the embodiment in FIG. 1 is viewed from a front;

FIG. 7(B) is an illustrative view showing one example of a state that the embodiment in FIG. 1 is viewed from a rear;

FIG. 8 is an illustrative view showing one example of an object scene captured by the embodiment in FIG. 1;

FIG. 9 is an illustrative view showing another example of the object scene captured by the embodiment in FIG. 1;

FIG. 10 is an illustrative view showing still another example of the object scene captured by the embodiment in FIG. 1;

FIG. 11 is a flowchart showing one portion of an operation of a CPU applied to the embodiment in FIG. 1;

FIG. 12 is a flowchart showing another portion of the operation of the CPU applied to the embodiment in FIG. 1;

FIG. 13 is a flowchart showing still another portion of the operation of the CPU applied to the embodiment in FIG. 1;

FIG. 14 is a flowchart showing yet still another portion of the operation of the CPU applied to the embodiment in FIG. 1;

FIG. 15 is a flowchart showing another portion of the operation of the CPU applied to the embodiment in FIG. 1;

FIG. 16 is a flowchart showing still another portion of the operation of the CPU applied to the embodiment in FIG. 1;

FIG. 17 is a flowchart showing yet still another portion of the operation of the CPU applied to the embodiment in FIG. 1;

FIG. 18 is a flowchart showing another portion of the operation of the CPU applied to the embodiment in FIG. 1; and

FIG. 19 is a flowchart showing one portion of an operation of a CPU applied to another embodiment.

### DETAILED DESCRIPTION OF THE PREFERRED EMBODIMENTS

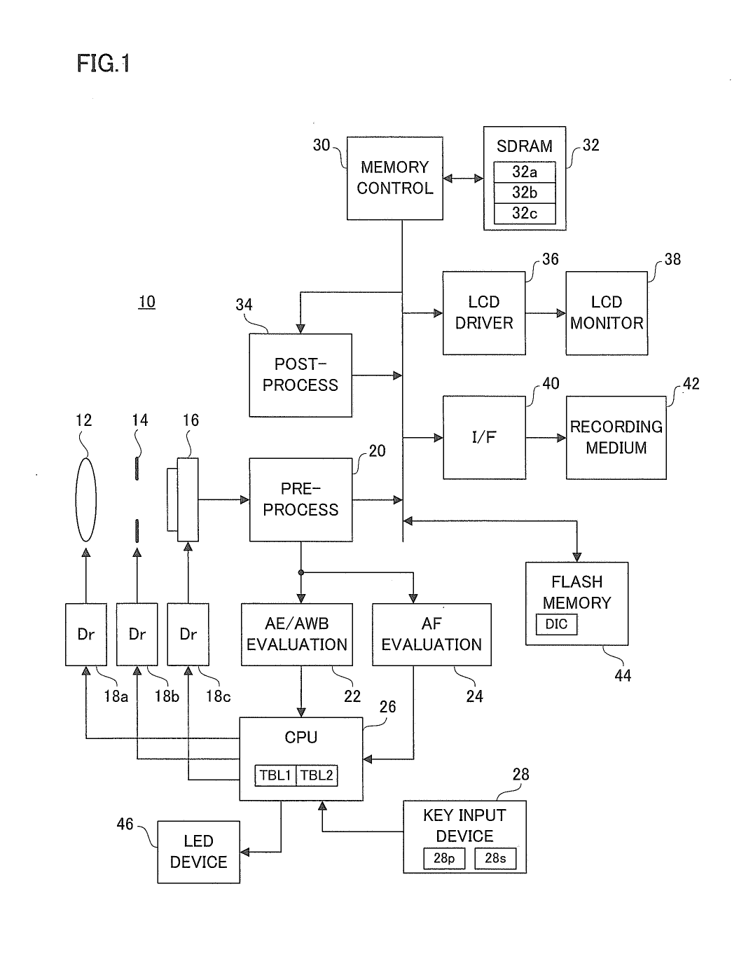

With reference to FIG. 1, a digital camera 10 according to this embodiment includes a focus lens 12 and an aperture unit 14 respectively driven by drivers 18a and 18b. An optical image of an object scene that undergoes these components is irradiated onto an imaging surface of an imager 16, and subjected to photoelectric conversion. Thereby, electric charges representing the object scene image are produced.

When a power supply key 28p on a key input device 28 is manipulated, in order to begin a through image process under an imaging task, a CPU 26 commands a driver 18c to repeat an exposure operation and a thinning-out reading-out operation. The driver 18c, in response to a vertical synchronization signal Vsync periodically generated from an SG (Signal Generator) not shown, exposes the imaging surface, and reads out one portion of the electric charges produced on the imaging surface in a raster scanning manner. From the imager 16, a low-resolution raw image signal based on the read-out electric charges is periodically outputted.

A pre-processing circuit 20 performs processes such as a CDS (Correlated Double Sampling), an AGC (Automatic Gain Control), an A/D conversion, on the raw image signal outputted from the imager 16, and outputs raw image data being a digital signal. The outputted raw image data is written in a raw image area 32a of an SDRAM 32 through a memory control circuit 30.

A post-processing circuit 34 reads out the raw image data accommodated in the raw image area 32a through the memory controlling circuit 30, and performs processes such as a white balance adjustment, a color separation, and a YUV conversion, on the read-out raw image data. The thus-produced image data of a YUV format is written in a YUV image area 32b of the SDRAM 32 through the memory control circuit 30.

An LCD driver 36 repeatedly reads out the image data accommodated in the YUV image area 32b through the memory control circuit 30, and drives an LCD monitor 38 based on the read-out image data. As a result, a real-time moving image (through image) of the object scene is displayed on a monitor screen.

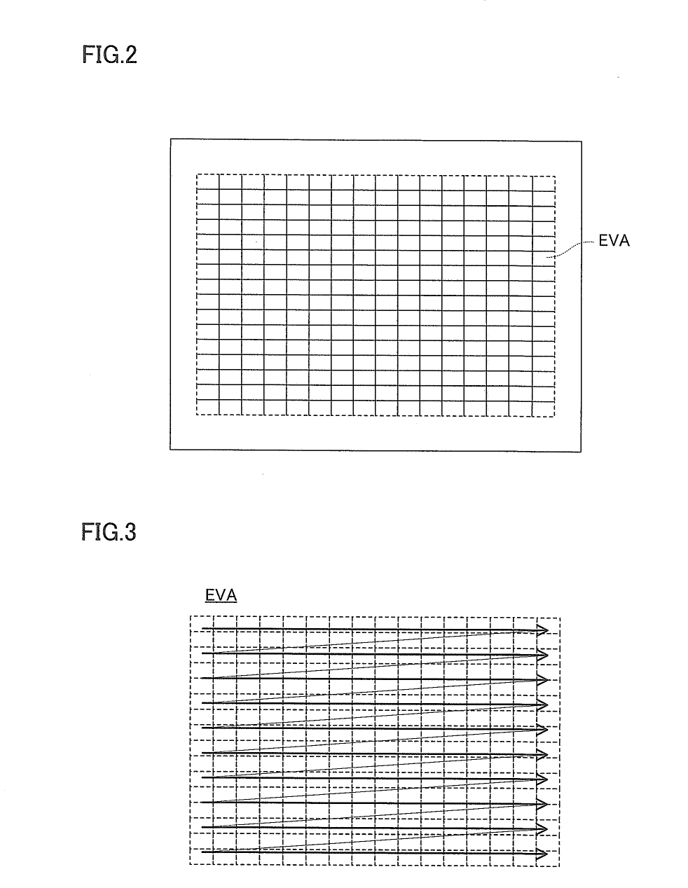

With reference to FIG. 2, an evaluation area EVA is allocated to a center of the imaging surface. The evaluation area EVA is divided into 16 portions in each of a horizontal direction and a vertical direction, and therefore, 256 divided areas form the evaluation area EVA. Moreover, in addition to the above-described processes, the pre-processing circuit 20 executes a simple RGB converting process which simply converts the raw image data into RGB data.

An AE/AWB evaluating circuit 22 integrates the RGB data belonging to the evaluation area EVA, out of the RGB data produced by the pre-processing circuit 20, at each generation of the vertical synchronization signal Vsync. Thereby, 256 integral values, i.e., 256 AE/AWB evaluation values, are outputted from the AE/AWB evaluating circuit 22 in response to the vertical synchronization signal Vsync.

Moreover, an AF evaluating circuit 24 extracts a high-frequency component of G data belonging to the same evaluation area EVA, out of the RGB data outputted from the pre-processing circuit 20, and integrates the extracted high-frequency component at each generation of the vertical synchronization signal Vsync. Thereby, 256 integral values, i.e., 256 AF evaluation values, are outputted from the AF evaluating circuit 24 in response to the vertical synchronization signal Vsync.

The CPU 26 executes a through image-use AE/AWB process based on the output from the AE/AWB evaluating circuit 22, in parallel with the through-image process, so as to calculate an appropriate EV value and an appropriate white-balance adjustment gain. An aperture amount and an exposure time period that define the calculated appropriate EV value are set to the drivers 18b and 18c, respectively. Moreover, the calculated appropriate white-balance adjustment gain is set to the post-processing circuit 34. As a result, a brightness and a white balance of the through image are adjusted moderately.

Furthermore, the CPU 26 executes a through image-use AF process based on the output from the AF evaluating circuit 24, under a continuous AF task in parallel with the through-image process. The focus lens 12 is set to a focal point by the driver 18a when the output of the AF evaluating circuit 24 satisfies an AF starting condition. Thereby, a focus of the through image is moderately adjusted.

When a shutter button 28s is half-depressed, the CPU 26 interrupts the continuous AF task, and executes a recording-use AF process under the imaging task. Also the recording-use AF process is executed based on the output of the AF evaluating circuit 24. Thereby, the focus is adjusted strictly. Thereafter, the CPU 26 executes the recording-use AE process based on the output of the AE/AWB evaluating circuit 22 so as to calculate the optimal EV value. Similar to the case described above, an aperture amount and an exposure time period that define the calculated optimal EV value are set to the drivers 18b and 18c, respectively. As a result, the brightness of the through image is adjusted strictly.

When the shutter button 28s is fully depressed, the CPU 26 commands the driver 18c to execute an exposure operation and an all-pixel reading operation once each, for a recording process, and furthermore, the CPU 26 starts an I/F 40. The driver 18c exposures the imaging surface in response to the vertical synchronization signal Vsync, and reads out all of the electric charges produced thereby from the imaging surface in a raster scanning manner. From the imager 16, one frame of raw image signal having a high resolution is outputted.

The raw image signal outputted from an imager 16 is converted into raw image data by the pre-processing circuit 20, and the converted raw image data is written in a recording image area 32c of the SDRAM 32 by the memory controlling circuit 30. The CPU 26 calculates the optimal white-balance adjustment gain based on the raw image data accommodated in the recording image area 32c, and sets the calculated optimal white-balance adjustment gain to the post-processing circuit 34.

The post-processing circuit 34 reads out the raw image data accommodated in the raw image area 32a through the memory controlling circuit 30, converts the read-out raw image data into YUV-formatted image data having the optimal white balance, and mites the converted image data in the recording image area 32c through the memory control circuit 30. The I/F 40 reads out the image data thus accommodated in the recording image area 32c through the memory control circuit 30, and records the read-out image data in a recording medium 42 in a file format.

It is noted that the through-image process is resumed at a time point when the raw image data having a high resolution is secured in the recording image area 32c. Also the continuous AF task is re-started at this time point.

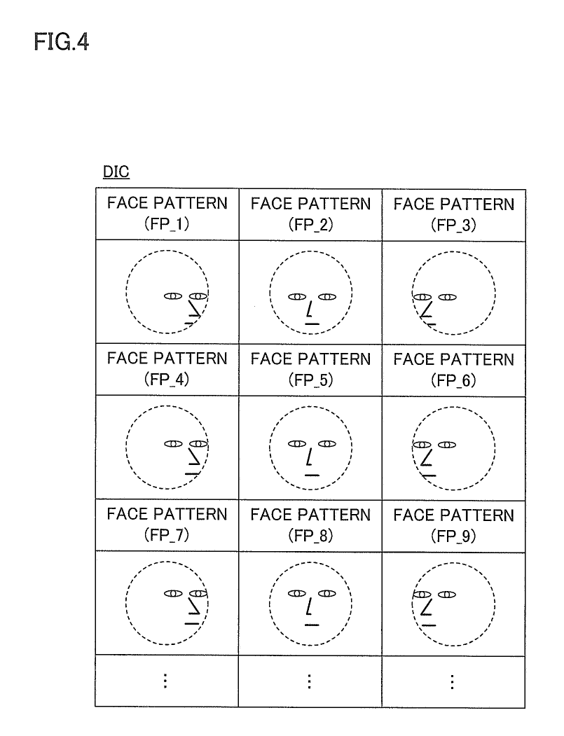

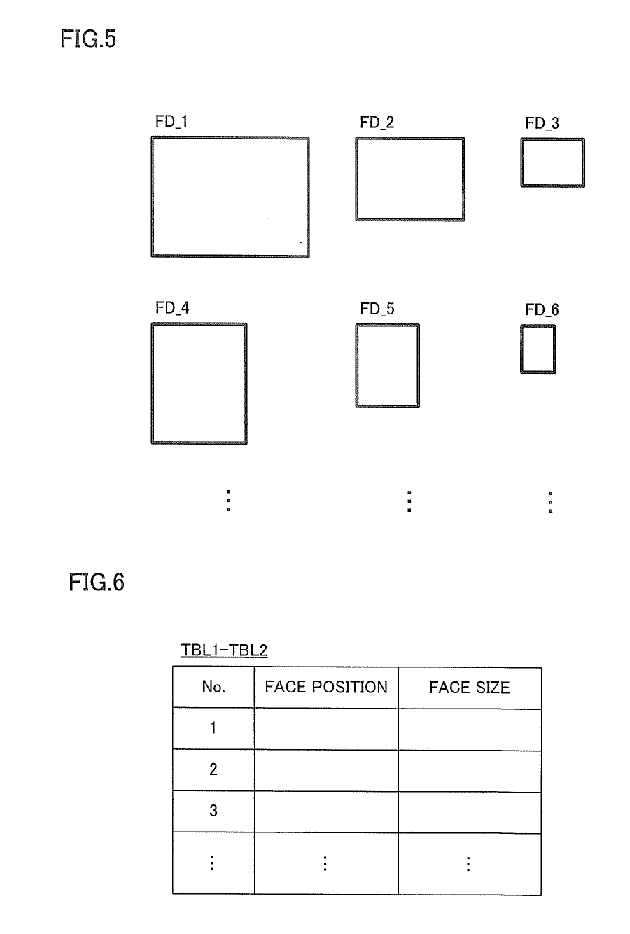

The CPU 26 repeatedly searches the face image of a person from the low-resolution raw image data accommodated in the raw image area 32a of the SDRAM 32, under a face detecting task executed in parallel with the through-image process. For such a face detecting task, a dictionary DIC shown in FIG. 4, a plurality of face-detection frame structures FD_1, FD_2, FD_3, . . . shown in FIG. 5, and two tables TBL1 and TBL2 shown in FIG. 6 are prepared.

According to FIG. 4, a plurality of face patterns FP_1, FP_2, . . . are registered in the dictionary DIC. Moreover, according to FIG. 5, the face-detection frame structures FD_1, FD_2, FD_3, . . . have shapes and/or dimensions different to one another. Furthermore, each of the tables TBL1 and TBL2 shown in FIG. 6 is equivalent to a table on which face-frame-structure information is written, and is formed by a column in which a position of the face image (position of the face-detection frame structure at a time point at which the face image is detected) is written and a column in which a size of the face image (size of the face-detection frame structure at a time point at which the face image is detected) is written.

In the face detecting task, firstly, the table TBL1 is designated as a current frame table on which the face-frame-structure information of a current frame is held. However, the designated table is updated between the tables TBL1 and TBL2 for each frame. In a subsequent frame, the current frame table is a prior frame table. Upon completion of designation of the current frame table, a variable K is set to “1” and a face-detection frame structure FD_K is set to an upper left of the evaluation area EVA shown in FIG. 6, i.e., a face-detection beginning position.

When the vertical synchronization signal Vsync is generated, out of the current-frame raw image data accommodated in the raw image area 32a of the SDRAM 32, partial image data belonging to the face-detection frame structure FD_K is checked with each of a plurality of face patterns FP_1, FP_2, . . . written in the dictionary DIC shown in FIG. 4. When it is determined that a partial image to be noticed matches any one of the face patterns, a current position and a size of the face-detection frame structure FD_K are written on the current frame table as the face-frame-structure information.

The face-detection frame structure FD_K is moved by each predetermined amount in a raster direction according to a manner shown in FIG. 3, and subjected to the above-described checking process at a plurality of positions on the evaluation area EVA. Then, at each time the face image of a person is discovered, the face-frame-structure information corresponding to the discovered face image (i.e., the current position and the size of the face-detection frame structure FD_K) is written one after another on the current frame table.

When the face-detection frame structure FD_K reaches a lower right of the evaluation area EVA, i.e., a face-detection ending position, the variable K is updated, and the face-detection frame structure FD_K corresponding to a value of the updated variable K is re-placed at the face-detection beginning position. Similarly to the above-described case, the face-detection frame structure FD_K is moved in a raster direction on the evaluation area EVA, and the face-frame-structure information corresponding to the face image detected by the checking process is written on the current frame table. Such a face recognizing process is repeatedly executed until a face-detection frame structure FD_Kmax (Kmax: a number of the face-detection frame structure at a tail end) reaches the face-detection ending position.

When the face-detection frame structure FD_Kmax reaches the face-detection ending position, the LCD driver 36 is commanded to display a face-frame-structure character based on the face-frame-structure information written on the current frame table. The LCD driver 36 displays the face-frame-structure character according to the command, on the LCD monitor 38 in an OSD manner.

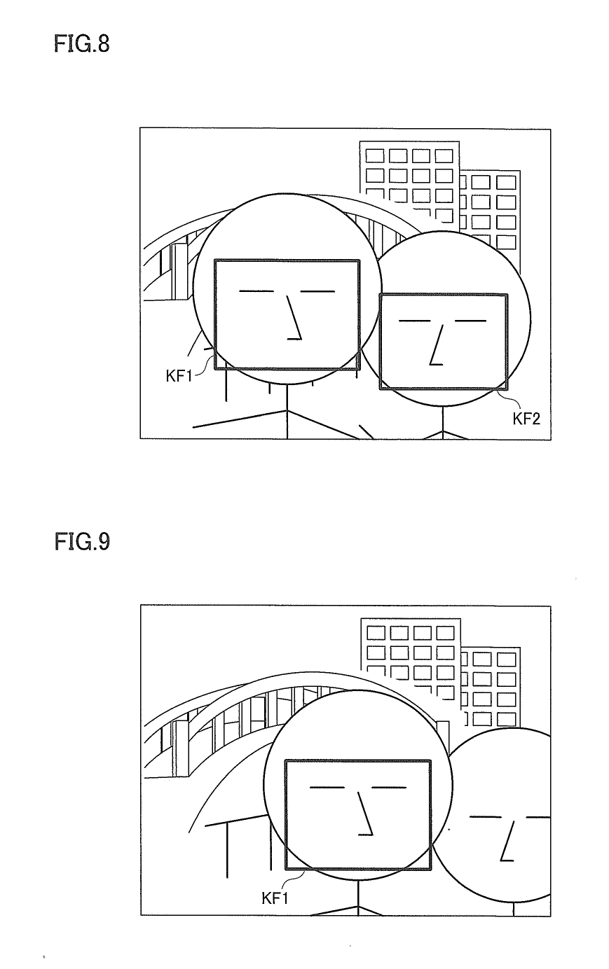

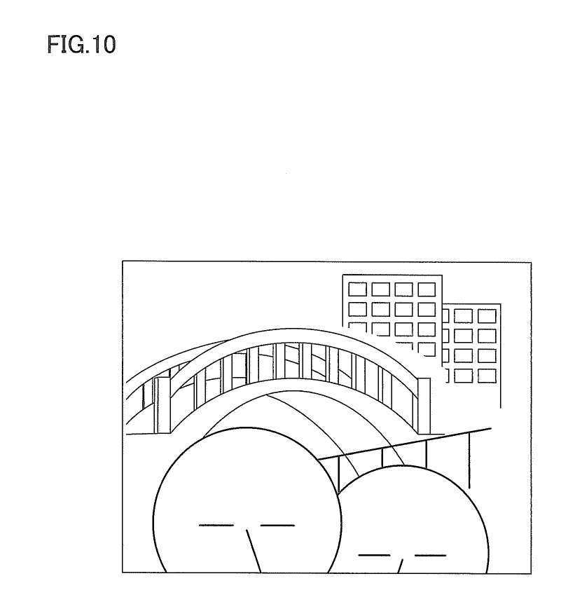

Therefore, when an object scene shown in FIG. 8 is captured, the face detection for two persons is successful. Then, two face frame structures KF1 and KF2 are displayed on the LCD monitor 38. Moreover, when an object scene shown in FIG. 9 is captured, the face detection for one person is successful. Then, one face frame structure KF1 is displayed on the LCD monitor 38. Furthermore, when an object scene shown in FIG. 10 is captured, the face detection for both two persons is unsuccessful. Then, no face frame structure is displayed.

Upon completion of the display process of the face-frame-structure character, the designated table is updated and the updated designated table is initialized. Moreover, the variable K is set to “1”. A face recognizing process of a subsequent frame is begun in response to the generation of the vertical synchronization signal Vsync.

In parallel with such a face detecting task, the CPU 26 defines a position and a shape of a parameter adjustment area ADJ referenced for the AE/AWB process and the AF process, under an adjustment-area controlling task.

In the adjustment-area controlling task, the prior frame table on which the face-frame-structure information is finalized is designated in response to the generation of the vertical synchronization signal Vsync, and whether or not the face-frame-structure information is written on the prior frame table is determined.

When at least one face frame structure is written on the prior frame table, one portion of the divided area covering the area within the face frame structure, out of the 256 divided areas forming the evaluation area EVA, is defined as the parameter adjustment area ADJ. On the other hand, when no face frame structure is written on the prior frame table, the whole evaluation area EVA is defined as the parameter adjustment area ADJ.

The above-described through image-use AE/AWB process and the recording-use AE/AWB process are executed based on the AE/AWB evaluation values belonging to the parameter adjustment area ADJ, out of the 256 AE/AWB evaluation values outputted from the AE/AWB evaluating circuit 22. Moreover, also the through image-use AF process and the recording-use AF process are executed based on the AF evaluation values belonging to the parameter adjustment area ADJ, out of the 256 AF evaluation values outputted from the AF evaluating circuit 24. Thereby, an adjustment accuracy for the imaging parameters such as an exposure amount and a focus is improved.

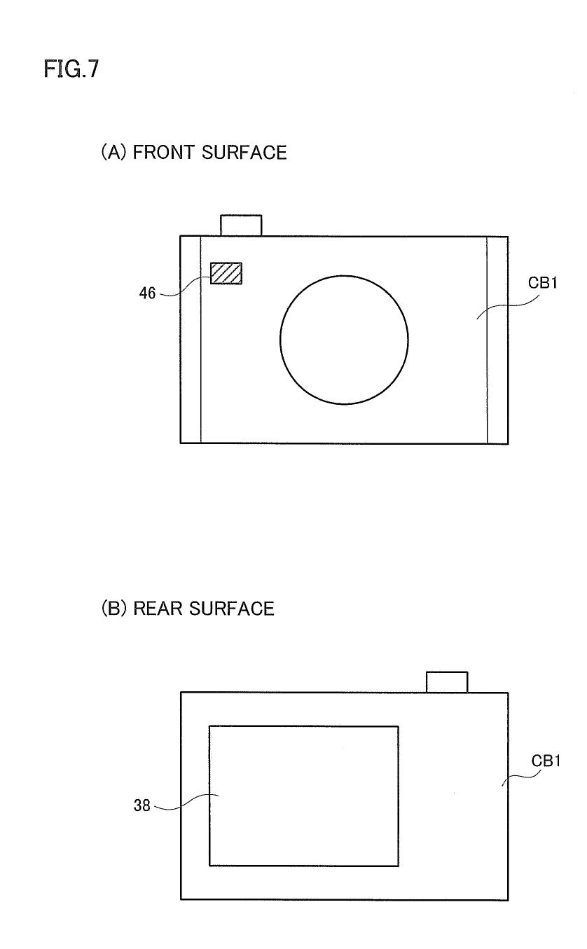

Moreover, the CPU 26 controls a light-emitting operation of an LED device 46 arranged on a front surface of a camera casing CB1 according to a manner shown in FIG. 7(A), under an LED controlling task in parallel with the above-described face detecting task. It is noted that the LCD monitor 38 is arranged on a rear surface of the camera casing CB1 according to a manner shown in FIG. 7(B). Therefore, the LED device 46 emits light toward a front of the camera casing CB1, and the LCD monitor 38 displays an image toward a rear of the camera casing CB1.

In the LED controlling task, when the shutter button 28s is in a manipulated state (half-depressed state), the prior frame table on which the face-frame-structure information is finalized is designated in response to the generation of the vertical synchronization signal Vsync, and whether or not the face-flame-structure information is written on the prior frame table is determined.

When even one face frame structure is not written on the prior frame table, the LED device 46 is set to non-light emission. When a single face frame structure is written on the prior frame table, the LED device 46 emits light in red. When two or more face frame structures are written on the prior frame table, the LED device 46 emits light in green. In this manner, notifications different depending on each detection state of the face image are outputted toward the object scene.

Such a notification controlling process of the LED device 46 is repeatedly executed as long as the shutter button 28s is in a manipulated state (half-depressed state). When the manipulation of the shutter button 28s is cancelled, the LED device 46 is set to non-light emission.

Therefore, when the face detection for two persons is successful as shown in FIG. 8, the LED device 46 emits light in green. Moreover, when the face detection for one person only is successful as shown in FIG. 9, the LED device 46 emits light in red. Furthermore, when the face detection for both two persons is unsuccessful as shown in FIG. 10, the LED device 46 is set to non-light emission.

When the light-emitting operation (notifying operation) of the LED device 46 arranged on the front surface of the camera casing CB1 is differed depending on each detection state of the face image, an object scene side becomes capable of confirming the detection state of the face image. As a result, a manipulability when photographing a user him/herself (so-called self shooting) is particularly improved.

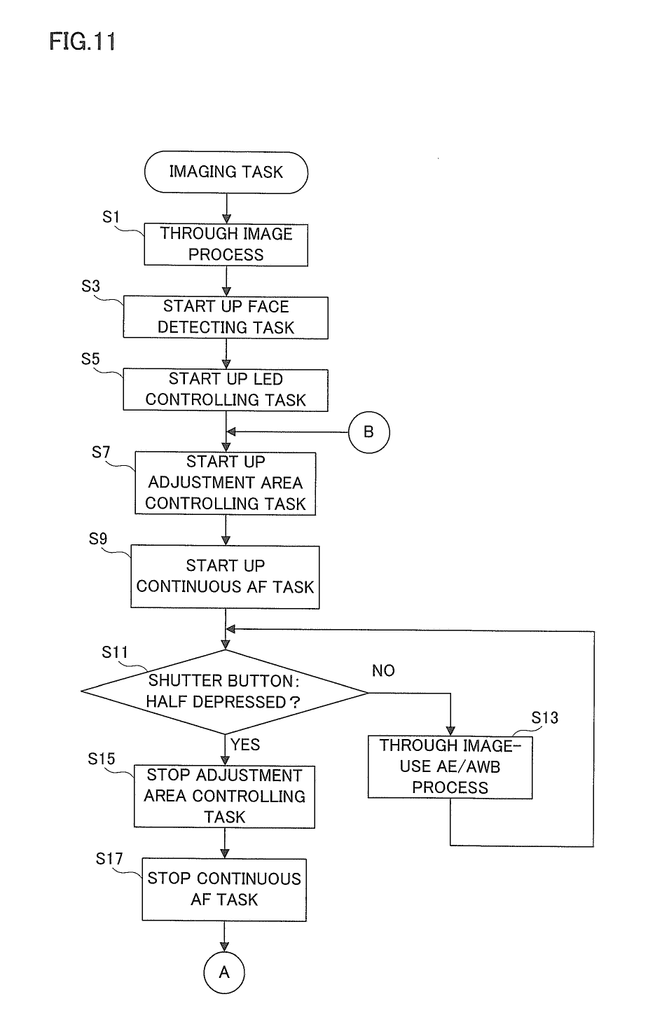

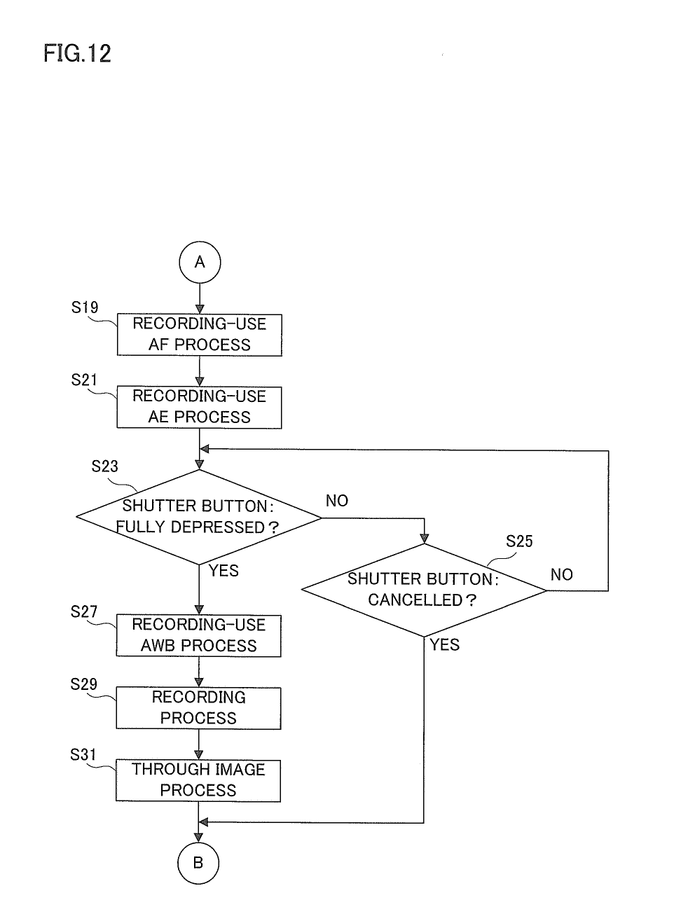

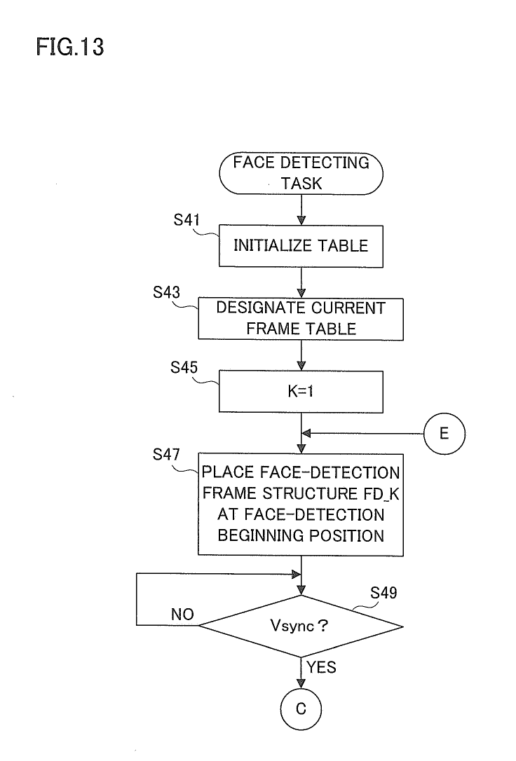

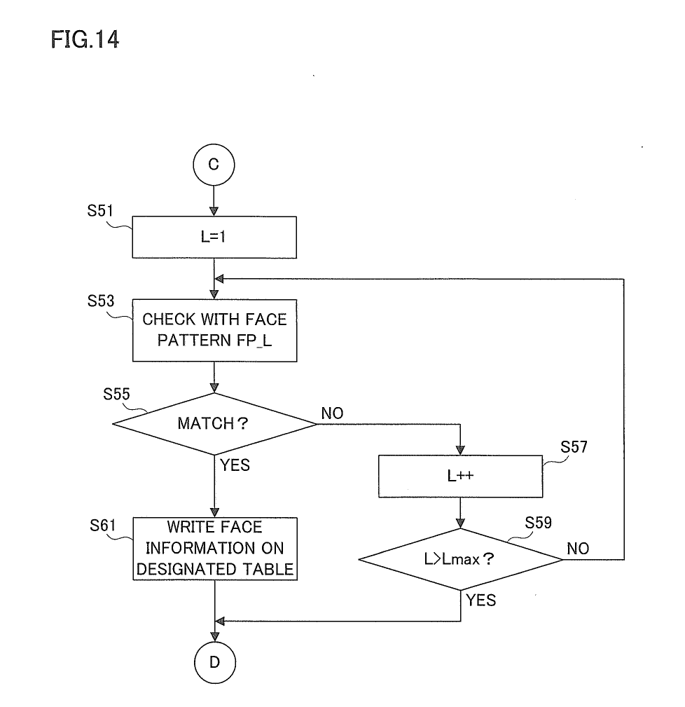

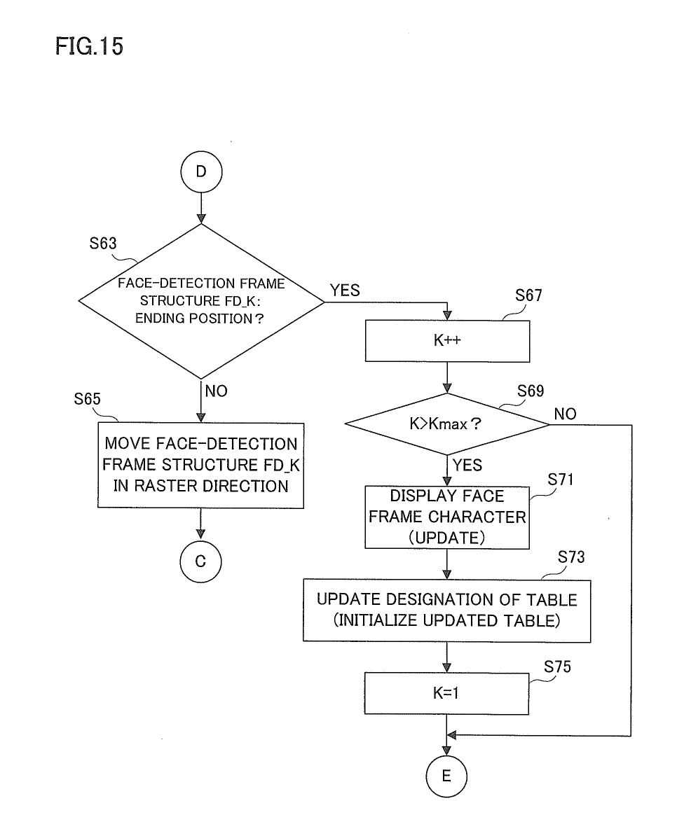

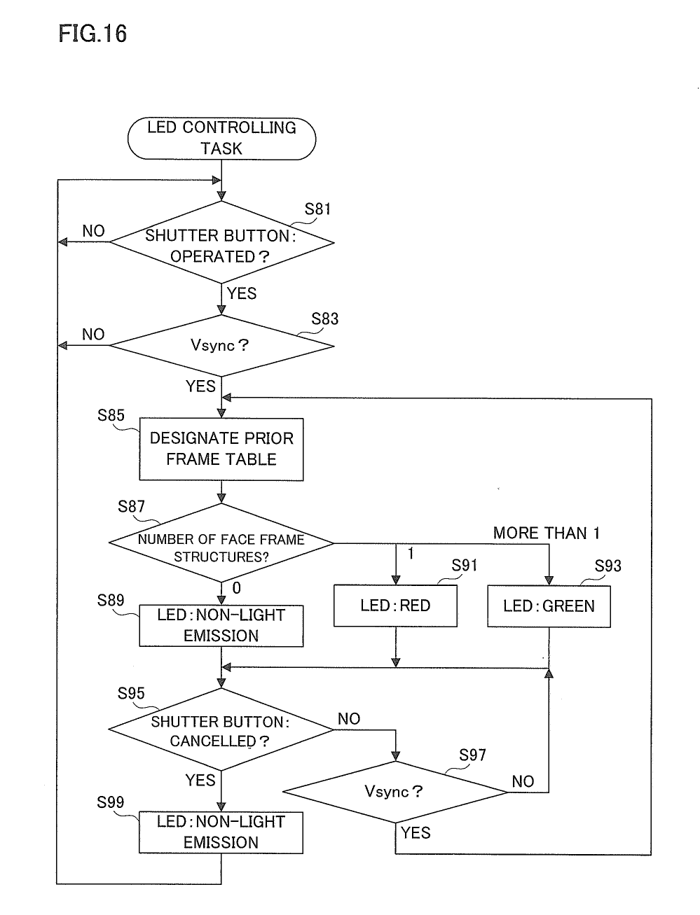

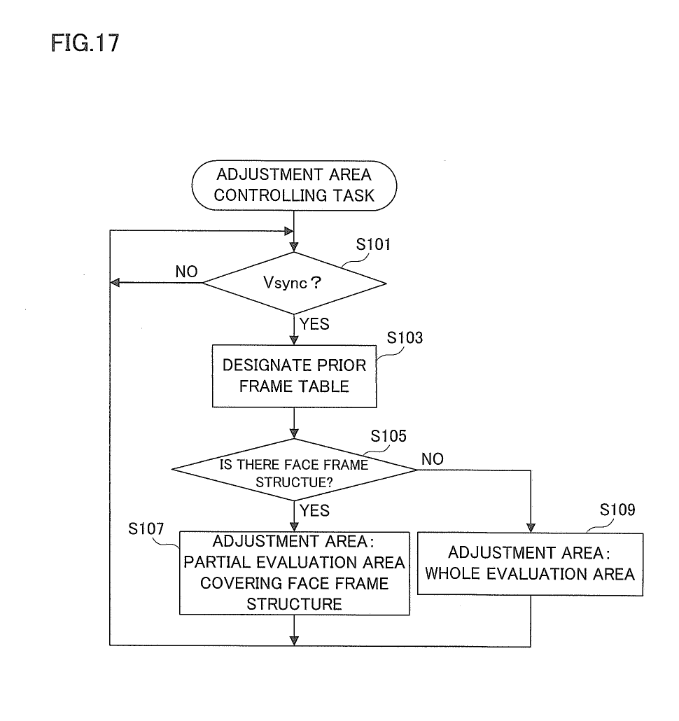

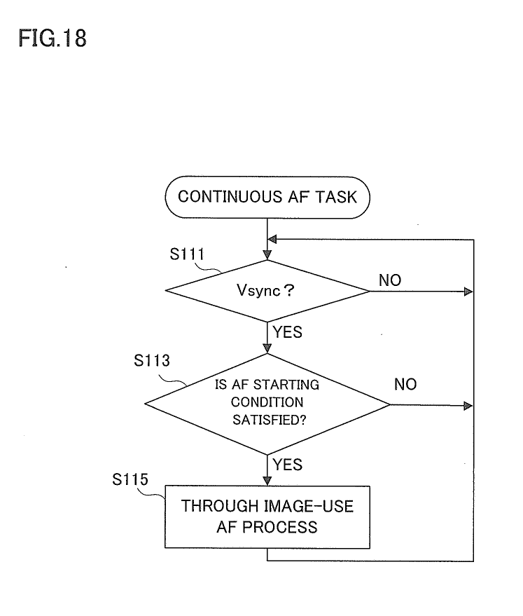

The CPU 26 executes in parallel a plurality of tasks including an imaging task shown in FIG. 11 and FIG. 12, a face detecting task shown in FIG. 13 to FIG. 15, an LDE controlling task shown in FIG. 16, an adjustment-area controlling task shown in FIG. 17, and a continuous AF task shown in FIG. 18. Control programs corresponding to these tasks are stored in a flash memory 44.

With reference to FIG. 11, the through-image process is executed in a step S1. As a result, the through image representing the object scene is displayed on the LCD monitor 38. In a step S3, the face detecting task is started, and in a step S5, the LED controlling task is started. Subsequently, in a step S7, the adjustment-area controlling task is started, and in a step S9, the continuous AF task is started.

In a step S11, whether or not the shutter button 28s is half-depressed is determined, and as long as NO is determined, the through image-use AE/AWB process in a step S13 is repeated. The through image-use AE/AWB process is executed based on the AE/AWB evaluation value belonging to the parameter adjustment area ADJ, and thereby, the brightness and the white balance of the through image are moderately adjusted.

When YES is determined in the step S11, the adjustment-area controlling task is stopped in a step S15. Ina step S17, the continuous AF task is stopped. In a step S19, the recording-use AF process is executed, and in a step S21, the recording-use AE process is executed. The recording-use AE process is executed based on the AF evaluation values belonging to the parameter adjustment area ADJ, and the recording-use AE process is executed based on the AE/AWB evaluation values belonging to the parameter adjustment area ADJ. Thereby, the focus and the brightness of the through image are strictly adjusted.

In a step S23, whether or not the shutter button 28s is fully depressed is determined, and in a step S25, whether or not the manipulation of the shutter button 28s is cancelled is determined. When YES is determined in the step S23, the process advances to a step S27, and when YES is determined in the step S25, the process returns to the step S7. In the step S27, the recording-use AWB process is executed, and in a step S29, the recording process is executed. The recording-use AWB process is executed based on the AE/AWB evaluation values belonging to the parameter adjustment area ADJ. Thereby, a high-resolution object scene image having the optimal white balance is recorded in the recording medium 42. In a step S31, the through image process is resumed, and thereafter, the process returns to the step S7.

With reference to FIG. 13, in a step S41, the tables TBL1 and TBL2 are initialized, and in a step S43, the table TBL1 is designated as the current frame table. In a step S45, the variable K is set to “1”, and in a step S47, the face-detection frame structure FD_K is placed at the face-detection beginning position at an upper left of the evaluation area EVA.

It is noted that the current frame table is updated between the tables TBL1 and TBL2 by a process in a step S73 described later. Therefore, in a subsequent frame, the current frame table is the prior frame table.

In a step S49, whether or not the vertical synchronization signal Vsync is generated is determined, and when the determination result is updated from NO to YES, the variable L is set to “1” in a step S51. In a step S53, the partial image belonging to the face-detection frame structure FD_K is checked with a face pattern FP_L registered in the dictionary DIC, and in a step S55, whether or not the partial image of the face-detection frame structure FD_K matches the face pattern FP_L is determined.

When NO is determined, the variable L is incremented in a step S57. In a step S59, whether or not the incremented variable L exceeds a constant Lmax (Lmax: total number of face patterns registered in the dictionary DIC) is determined. Then, when L. Lmax is established, the process returns to the step S53 while when L>Lmax is established, the process advances to a step S63.

When YES is determined in the step S55, the process advances to a step S61 so as to write, as the face-frame-structure information, the current position and the size of the face-detection frame structure FD_K on the designated table. Upon completion of the process in the step S61, the process advances to the step S63.

In the step S63, it is determined whether or not the face-detection frame structure FD_K reaches the face-detection ending position at a lower right of the evaluation area EVA. When NO is determined in this step, the face-detection frame structure FD_K is moved in a raster direction by a predetermined amount in a step S65, and thereafter, the process returns to the step S51. On the other hand, when YES is determined in the step S63, the variable K is incremented in a step S67, and whether or not the incremented variable K exceeds “Kmax” is determined in a step S69.

Then, when K≦Kmax is established, the process returns to the step S47 while when K>Kmax is established, the process advances to a step S71. In the step S71, the LCD driver 36 is commanded to display the face-frame-structure character based on the face-frame-structure information written on the current frame table. As a result, the face-frame-structure character is displayed on the through image in an OSD manner. In the step S73, the designated table is updated and the updated designated table is initialized. Upon completion of the process in the step S73, the variable K is set to “1” in a step S75, and thereafter, the process returns to the step S47.

With reference to FIG. 16, in a step S81, whether or not the shutter button 28s is manipulated (half-depressed) is determined, and in a step S83, whether or not the vertical synchronization signal Vsync is generated is determined. When even one of the steps S81 and S83 is NO, the process returns to the step S81, and when YES is determined in the both steps S81 and S83, the process advances to a step S85.

In the step S85, the prior frame table is designated, and in a step S87, the number of face frame structures written on the prior frame table is determined. When the number of face frame structures is “0”, the LED device 46 is set to non-light emission in a step S89, when the number of face frame structures is “1”, the LED device 46 is caused to emit light in red in a step S91, and when the number of face frame structures is equal to or more than “2”, the LED device 46 is caused to emit light in green in a step S93.

Upon completion of the process in the step S89, S91, or S93, whether or not the manipulation of the shutter button 28s is cancelled is determined in a step S95, and whether or not the vertical synchronization signal Vsync is generated is determined in a step S97. When NO is determined in the both steps S95 and S97, the process returns to the step S95. When YES is determined in the step S97, the process returns to the step S85. When YES is determined in the step S95, the LED device 46 is set to non-light emission in a step S99, and then, returns to the step S81.

With reference to FIG. 17, in a step S101, whether or not the vertical synchronization signal Vsync is generated is determined, and when the determination result is updated from NO to YES, the prior frame table is designated in a step S103. In a step S105, whether or not the face frame structure is written on the prior frame table is determined, and when YES is determined, the process advances to a step S107 while when NO is determined, the process advances to a step S109.

In the step S107, one portion of the divided areas covering the area within the face frame structure written on the designated table, out of the 256 divided areas forming the evaluation area EVA, is defined as the adjustment area ADJ. In the step S109, the whole evaluation area EVA is defined as the adjustment area ADJ. Upon completion of the process in the step S107 or S109, the process returns to the step S101.

With reference to FIG. 18, in a step S111, whether or not the vertical synchronization signal Vsync is generated is determined. When the determination result is updated from NO to YES, whether or not the AF starting condition is satisfied is determined in a step S113. When NO is determined in this step, the process returns to the step S111 as it is. However, when YES is determined, the through image-use AF process is executed in a step S115, and then, the process returns to the step S111.

The determining process of whether or not the AF starting condition is satisfied is executed based on the AF evaluation values belonging to the parameter adjustment area ADJ, and also the through image-use AF process is executed based on the AF evaluation values belonging to the parameter adjustment area ADJ. Thereby, the focus of the through image is continuously adjusted.

As is seen from the above description, the image representing the object scene is produced by the imager 16. The CPU 26 searches the face image of a person, from the image produced by the imager 16 (S41 to S69, and S73 to S75), and outputs the notifications different depending on each search result toward the object scene (S85 to S93).

Thus, the face image of a person is searched from the image representing the object scene, and the notifications different depending on each search result are output toward the object scene. Thereby, the object scene side is capable of confirming the detection state of the face image of a person, and as a result, a manipulability when photographing a user him/herself is particularly improved.

It is noted that in this embodiment, the notifications different depending on the search result of the face image are visually outputted by utilizing the LED device 46, and the notifications different depending on each search result of the face image, however, may be optionally outputted audibly by utilizing a speaker.

Moreover, in this embodiment, as the specific object image, the face image of a person is assumed. However, a face image of animals such as a dog and a cat may be optionally assumed instead thereof.

Furthermore, in this embodiment, a so-called digital still camera for recording a still image is assumed. However, the present invention is applicable also to a digital video camera for recording a moving image.

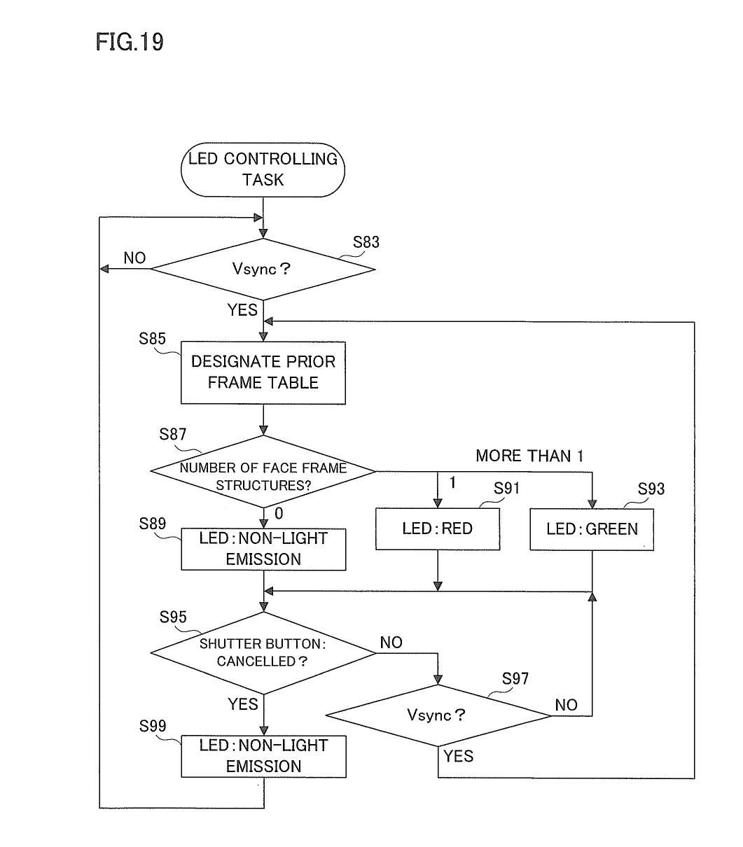

Still furthermore, in this embodiment, the light-emitting control of the LED device 46 is begun in response to the manipulation of the shutter button 28s (see FIG. 16). However, the light-emitting control of the LED device 46 may be optionally started in response to a power-supply input manipulation by the power supply key 28p. In this case, preferably, instead of the LED controlling task shown in FIG. 16, an LED controlling task shown in FIG. 19 is executed. The LED controlling task shown in FIG. 19 is the same as the LED controlling task shown in FIG. 16 except that the process in the step S81 shown in FIG. 16 is omitted. Thereby, the object scene side becomes capable of confirming the detection state of the face image of a person even before manipulating the shutter button 28s, resulting in further improvement of the manipulability particularly when photographing a user him/herself.

Furthermore, in this embodiment, the light emission color of the LED device 46 is modified according to the number of faces detected from the object scene. However, instead of modifying the light emission color, or along with modifying the light emission color, a blinking cycle of the LED device 46 may be optionally modified. Moreover, a plurality of LED devices are prepared and the number of LED devices caused to emit light may be optionally modified according to the number of detected faces.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An electronic camera, comprising:
an imager which produces an image representing an object scene;
a searcher which searches a specific object image from the image produced by said imager; and
a notifier which outputs notifications different depending on each search result of said searcher, toward the object scene.

2. An electronic camera according to claim 1, further comprising an adjustor which adjusts an imaging parameter according to a parameter-adjusting manipulation, wherein said notifier executes a notifying process in association with an adjusting process of said adjustor.

3. An electronic camera according to claim 1, wherein said notifier includes a determiner which determines the number of specific object images discovered by said searcher and a selector which selects a notifying manner corresponding to the number determined by said determiner.

4. An electronic camera according to claim 1, further comprising a recorder which records the image produced by said imager in response to a recording manipulation, wherein said determiner repeatedly executes the determining process until the recording manipulation is performed.

5. An electronic camera according to claim 1, wherein said imager repeatedly produces the image, said electronic camera, further comprising:
a moving image outputter which outputs a moving image based on the image produced by said imager, toward a predetermined direction; and
an information outputter which outputs information corresponding to the search result of said searcher, toward the predetermined direction.

6. An electronic camera according to claim 1, wherein the specific object image is equivalent to a face image of a person.

7. An imaging controlling program product executed by a processor of an electronic camera provided with an imager which produces an image representing an object scene, said imaging controlling program product comprising:
a searching step of searching a specific object image from the image produced by said imager; and
a notifying step of outputting notifications different depending on each search result in said searching step, toward the object scene.

8. An imaging controlling method executed by an electronic camera provided with an imager which produces an image representing an object scene, said imaging controlling method comprising:
a searching step of searching a specific object image from the image produced by said imager; and
a notifying step of outputting notifications different depending on each search result in said searching step, toward the object scene.
